(19) United States
(12) Patent Application Publication
(10) Pub. No.: US 2006/0113314 A1
(43) Pub. Date: Jun. 1, 2006

(54) Drug dispenser

(76) Inventors: Shoji Yuyama, Toyonaka-shi (JP); Shinji Yamaguchi, Toyonaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/523,823

(22) PCT Filed: Aug. 5, 2003
(86) PCT No.: PCT/JP03/09902

§ 371 Date: Sep. 7, 2005

(30) Foreign Application Priority Data
Aug. 5, 2002 (JP) 2002-227071
Oct. 18, 2002 (JP) 2002-305166

(51) Int. Cl. G07F 11/16

(52) U.S. Cl. 221/222

(57) ABSTRACT

A medicine feeder is composed of: a cassette 2 for housing medicines D in array; biasing member 6 for biasing the medicines D in the cassette 2 toward one end side; and a discharge member 16 disposed on one end portion of the cassette 2 for holding a medicine D in a holding recess portion 18 and discharging the medicines D singly by rotating movement. This makes it possible to ensure discharge of a prescribed quantity of medicines based on prescription data.

### TECHNICAL FIELD

The present invention relates to a medicine feeder which allows discharge of medicines singly.

### BACKGROUND ART

Medicines are conventionally housed in cassettes which are contained in a stock shelf in such a way that the cassettes can be pulled out. According to need, the cassettes are pulled out from the stock shelf to discharge appropriate medicines.

However, in the case of using the stock shelf, the location of the cassettes contained therein may affect access to the medicines housed in the cassettes since the medicines should be taken and held from an upper aperture of the pulled-out cassettes. Further, as a quantity of medicines housed in the cassettes is increased, not only the cassettes themselves are hard to be pulled out, but also medicines housed on the back side of the cassettes are difficult to be taken out. Further, in the case of a medicine such as anticancer drugs whose administration is strictly restricted, it is not desirable to allow free access to the medicine. However, adopting the structure featuring such solution as locking will deteriorate workability and also require an additional operation to confirm that the medicines are securely locked up.

Accordingly, it is a primary object of the present invention to provide a medicine feeder which makes it possible to ensure discharge of a prescribed quantity of medicines based on prescription data.

### DISCLOSURE OF THE INVENTION

According to the present invention, as a means to solve the problem stated above, there is provided a medicine feeder comprising: a cassette for housing medicines in array; biasing member for biasing the medicines in the cassette toward one end side; and a discharge member disposed on one end portion of the cassette for holding a medicine in a holding recess portion and discharging the medicine singly by rotating movement.

This structure makes it possible to ensure discharge of the medicines housed in the cassette singly by rotating operation of the discharge member. After one medicine is discharged, the next medicine is supplied to the holding recess portion of the discharge member by the biasing member, allowing smooth discharge operation afterward.

The discharge member should be structured to have a support face so as to support the next medicine while holding the medicine in the holding recess portion and rotating.

It is desirable that the discharge member rotates so as to be positioned in each of a reception position for holding the medicine in the holding recess portion inside the cassette and an extraction position for extracting the medicine held in the holding recess portion, so that medicines can constantly be discharged at the same extraction position with a minimum operation, which makes it possible to increase workability.

It is desirable to include: medicine detection member for detecting whether or not a medicine is present in the holding recess portion when the discharge member is positioned at the extraction position; and control device for allowing driving of the discharge member based on prescription data and a detection signal in the medicine detection member, which allows automatic discharge of a desired quantity of medicines.

It is desirable to include lock member for disabling the discharge member from rotating, wherein the control device controls the lock member so as to lock the discharge member at the reception position when discharge of a prescribed quantity of medicines based on prescription data is completed, which makes it possible to ensure automatic prevention of unauthorized discharge of medicines without manual assistance.

It is desirable that the discharge member has a notch on opposite walls constituting the holding recess portion to facilitate holding of the medicine, which allows easier operation of medicine discharge.

It is to be noted that the biasing member should preferably be structured to be able to apply a fixed load regardless of a quantity of medicines housed in the cassette, which allows more smooth operation of medicine discharge.

### BRIEF DESCRIPTION OF THE DRAWINGS

FIG. 1 is a schematic front view showing a medicine feeder in the present embodiment;

FIG. 2 is a fragmentary perspective view showing one example of a cassette of FIG. 1;

FIG. 3A is a perspective view showing a rotor adoptable for the cassette of FIG. 1;

FIG. 3B is a cross sectional view showing the rotor adoptable for the cassette of FIG. 1;

FIG. 4A is a side view showing the cassette shown in FIG. 1;

FIG. 4B is an enlarged view showing a rotor portion;

FIG. 4C is an enlarged view showing a stepping motor portion;

FIG. 5 is a view showing the cassette shown in FIG. 4A in medicine discharge state;

FIG. 6 is a view showing the cassette shown in FIG. 4A in locked state;

FIG. 7 is a perspective view showing a part of the front side of a housing portion shown in FIG. 1;

FIG. 8 is a perspective view showing a part of the back side of the housing portion shown in FIG. 1;

FIG. 9 is a block diagram showing the medicine feeder in the present embodiment;

FIG. 10 is a flow chart showing the operation process in the medicine feeder in the present embodiment;

FIG. 11A is a plane view showing a cassette in another embodiment;

FIG. 11B is a side view of FIG. 11A;

FIG. 12 is a schematic view showing a rotational driving mechanism of a rotor in another embodiment;

FIG. 13A is a plane view showing a cassette having an encoder in another embodiment;

FIG. 13B is a front view of FIG. 13A;

FIG. 14 is a schematic view showing a rotational driving mechanism of a rotor in another embodiment;

FIG. 15A and FIG. 15B are schematic views showing a discharge mechanism in another embodiment;

FIG. 16A and FIG. 16B are schematic views showing comparison of movement tracks of support faces each having a shaft portion of the rotor placed in a position different from each other;

FIG. 17A is a side view showing the side of a gear of the rotational driving mechanism of the rotor in still another embodiment after a cassette is mounted on a housing portion;

FIG. 17B is a side view showing the rotational driving mechanism of the rotor in the another embodiment before the cassette is mounted on the housing portion;

FIG. 18 is a perspective view showing a rotor portion of the cassette in the another embodiment;

FIG. 19 is a perspective view viewed from the opposite side from FIG. 18;

FIG. 20 is a fragmentary perspective view showing a housing portion in the another embodiment;

FIG. 21A is a side view showing the side of a lock member of the rotational driving mechanism of the rotor in the another embodiment before the cassette is mounted on the housing portion;

FIG. 21B is a side view showing the rotational driving mechanism of the rotor in the another embodiment before the cassette is mounted on the housing portion;

FIG. 22A is a plane view showing a cover mounted on the cassette;

FIG. 22B is a cross sectional view of FIG. 22A;

FIG. 23A is a cross sectional front view showing a rotational driving mechanism of a motor in still another embodiment;

FIG. 23B is an exploded plane view of FIG. 23A;

FIG. 24A is a cross sectional front view showing a rotational driving mechanism of a motor in another embodiment;

FIG. 24B is a front view of FIG. 24A;

FIG. 24C is a front view showing the rotor of FIG. 24B in the state of being rotated;

FIG. 25 is a view showing a finger print recognition screen.

FIG. 26 is a view showing an OK/NG selection screen;

FIG. 27 is a view showing a various operations screen;

FIG. 28 is a view showing an auto/manual screen;

FIG. 29 is a view showing a processed clients list screen;

FIG. 30 is a view showing a discharge operation screen;

FIG. 31 is a view showing an inquiry operation menu screen;

FIG. 32 is a view showing a prescription history inquiry screen;

FIG. 33 is a view showing a medicine administration search screen;

FIG. 34 is a view showing a medicine usage screen;

FIG. 35 is a view showing a replenishing operation screen;

FIG. 36 is a view showing a medicine usage per doctor screen;

FIG. 37 is a view showing a medicine usage per ward screen;

FIG. 38 is a view showing a medicine usage per controlled medicine screen;

FIG. 39 is a view showing a master maintenance screen;

FIG. 40 is a view showing a medicine master screen;

FIG. 41 is a view showing a daily report menu screen;

FIG. 42 is a view showing a daily report on replenishment screen;

FIG. 43 is a perspective view showing a rotor portion of a cassette in another embodiment;

FIG. 44A is a schematic explanatory view showing a rotational driving mechanism shown in FIG. 43 in an unlock position;

FIG. 44B is a fragmentary detailed perspective view of FIG. 44A;

FIG. 45A is a schematic explanatory view showing the rotational driving mechanism shown in FIG. 43 in a reference position;

FIG. 45B is a schematic explanatory view showing the rotational driving mechanism shown in FIG. 43 in an unlock position; and

FIG. 45C is a schematic explanatory view showing the rotational driving mechanism shown in FIG. 43 in the state of being rotated to a discharge position.

### BEST MODE FOR CARRYING OUT THE INVENTION

Embodiments of the invention will hereinafter be described with reference to the accompanying drawings.

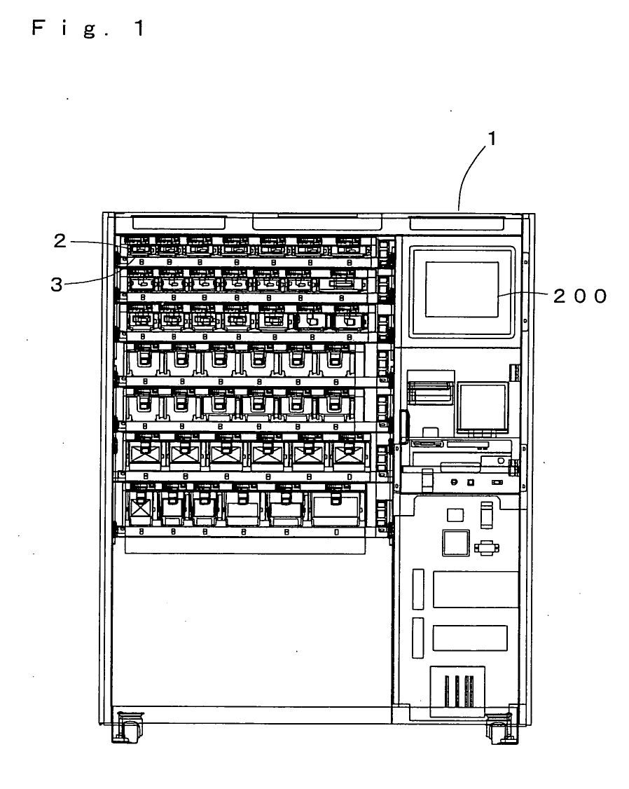

FIG. 1 shows a medicine feeder in the present embodiment. In the medicine feeder, a plurality of cassettes 2 are housed in a stock shelf 1 in matrix state. It is to be noted that an operation display panel 200 is provided on the front face of the stock shelf 1 to allow predetermined input and display.

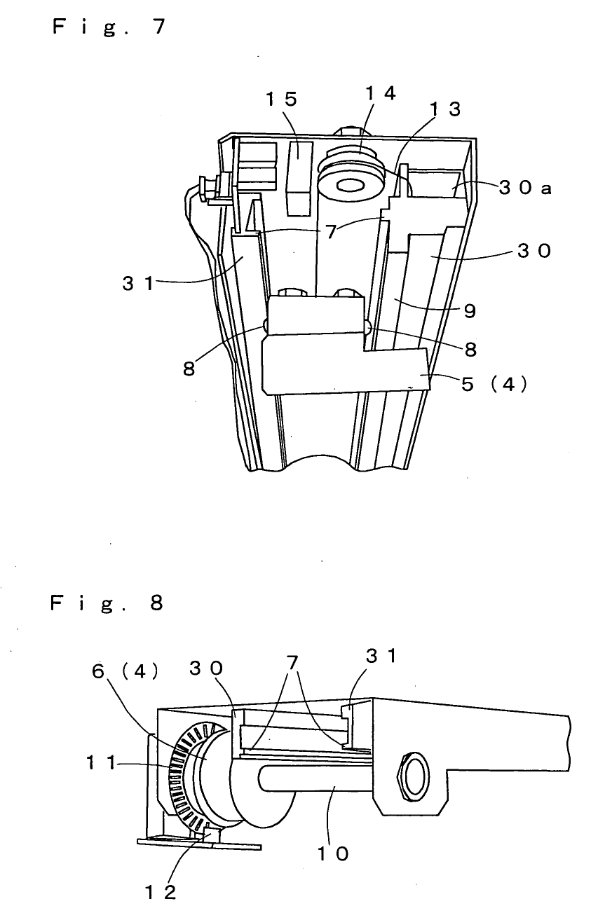

The stock shelf 1 includes a plurality of housing portions 3 with the cassettes 2 dismountable therefrom. On the bottom face constituting each housing portion 3, there is parallely provided a pair of guide rails (unshown) for guiding the cassette 2 along the detachment direction. Moreover, on the upper face side constituting each housing portion 3, as shown in FIG. 7 and FIG. 8, there is provided a biasing member 4 for sending a medicine D housed in the cassette 2 toward the front side of the stock shelf 1. The biasing member 4 is composed of a plate-like slide member 5 moving along guide members 30, 31 provided on facing surfaces, and a constant-load spring 6 for biasing the slide member 5 toward the front side of the stock shelf 1. On the facing surfaces of the guide members 30, 31, there is formed a protrusion line 7 extending along a longitudinal direction, and a bearing 8 of the slide member 5 rolls on the upper and lower faces of the protrusion line 7. On the lower face of one guide member 30, there is formed a cassette pressing portion 9 extending along a longitudinal direction, which presses a later-described lid body 17 for preventing the medicine D from floating up when the cassette 2 is mounted on the housing portion 3. The constant-load spring 6 is integrated with a rotary shaft 10 rotatably provided on the back side of the stock shelf 1 and with an encoder 11. The encoder 11 is in a disc shape, and a plurality of slits are formed on an outer circumferential portion along circumferential direction with prescribed pitches. Each slit is detected by a remaining quantity sensor 12 and a rotating position is counted so that a quantity of the medicines D in the cassette 2 mounted on the housing portion 3 can be detected. A spring portion of the constant-load spring 6 is connected to a wire 13. The wire 13 is extended to the front side of the stock shelf 1 through a rectangular hole 30a formed on one guide member 30, and is connected to the slide member 5 through a roller 14. Consequently, regardless of movement destination positions, the slide member 5 is constantly biased toward the front side of the stock shelf 1 with certain force. In the vicinity of the roller 14, an origin reset sensor 15 is placed. Without the cassette 2 mounted on the housing portion 3, the slide member 5 is positioned on the front side of the stock shelf 1 through the wire 13 by virtue of the constant-load spring 6. The origin reset sensor 15 is used to detect the slide member 5 moved to the front side while the cassette 2 is not yet mounted and to reset the count by the encoder 11. More particularly, the size of one medicine occupying the longitudinal direction of the cassette 2 (diameter in ampul and width size in medicine box) and an output pulse value from the encoder 11 are associated in advance and stored. Then, when the cassette 2 is mounted, a quantity of the medicines D is calculated based on the output pulse generated when the slide member 5 is pushed by the housed medicine D and moved to the back side. In the case of discharging the medicine D, a remaining quantity of the medicines D is calculated by subtracting a detected output pulse value of the encoder 11 from an output pulse value stored when the cassette 2 is mounted.

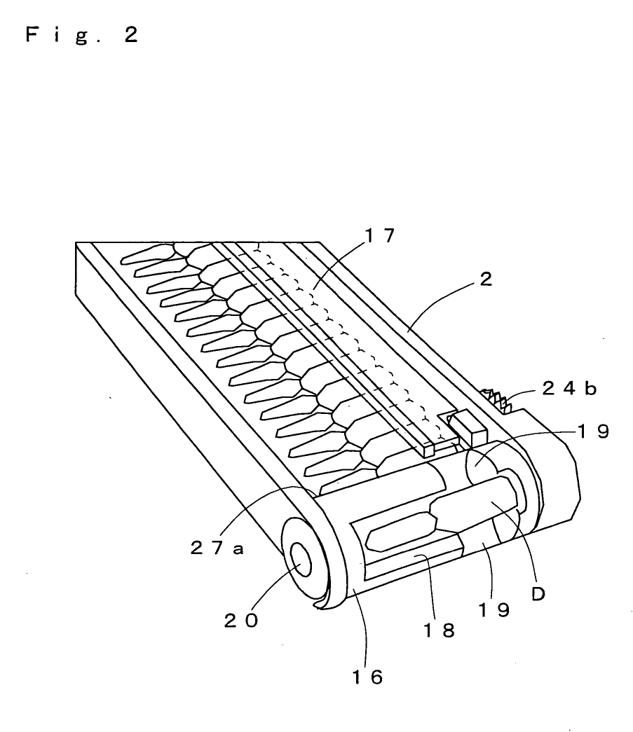

As shown in FIG. 2, each of the cassettes 2 is in a groove shape open to the upper side, and a rotor 16 serving as the discharge member is provided on one end portion so that the medicines D can be discharged singly. Further, in the cassette 2, a lid body 17 which covers a part of the cassette 2 along the upper aperture edge portion is rotatably provided in the state of being biased toward closed direction. In the cassette 2, the medicines D are housed in an arrayed state, and a part of the housed medicines D is pressed by the cassette pressing portion 9 (see FIG. 7). Further, an coupling recess portion (unshown) is formed on the bottom face of the cassette 2, and a hook (unshown) provided on the side of the stock shelf 1 is coupled therewith so that when the cassette 2 is mounted, clicking sensation is provided. Further, a recess portion 2a (unshown in FIG. 2) is formed on the front side of the cassette 2, that is the side wall on which the rotor 16 is provided, so that when the cassette 2 is pulled out from the stock shelf 1, the cassette 2 is easy to grasp with the fingers.

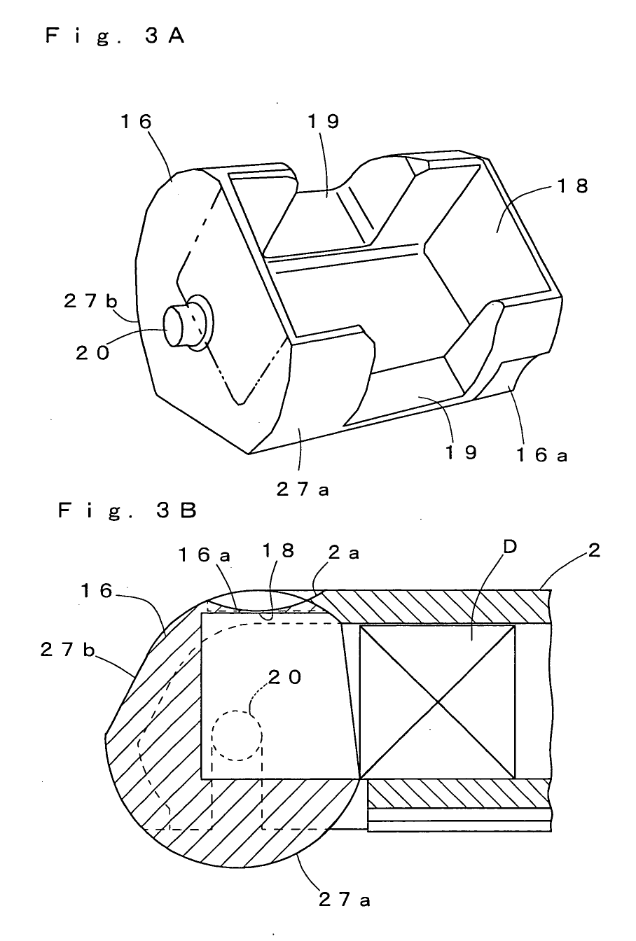

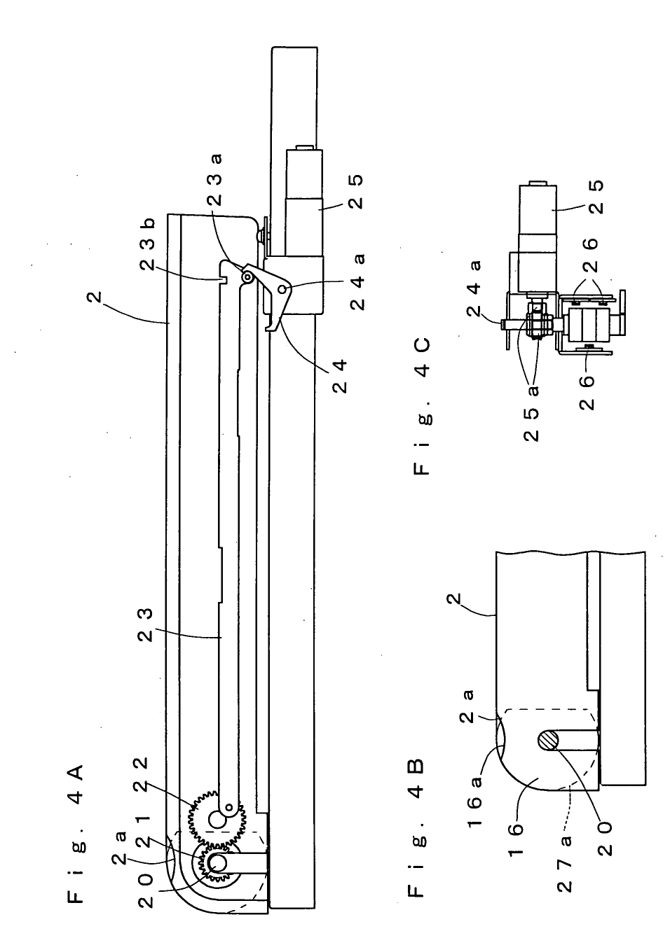

The rotor 16 includes a small-size rotor for discharging ampules and the like as shown in FIG. 2 and a large-size rotor for discharging boxes housing vials and the like as shown in FIGS. 3A and 3B. As shown in FIG. 3, the rotor 16 has a holding recess portion 18 for holding the medicine D. A notch 19 is formed on both side faces constituting the holding recess portion 18 for assisting easy discharge of the medicine D. At least on the right end-side outer circumferential portion of the rotor 16 (or the left end-side outer circumferential portion), there is formed a recess portion 16a which is connected to the recess portion 2a formed on the cassette 2 at a holding position. The recess portion 16a is provided if the cassette 2 is small and so the recess portion 2a is not enough for assisting gripping with the fingers. On the central portion on the end face of the rotor 16, a shaft portion 20 protrudes and is rotatably supported by the cassette 2. As shown in FIG. 4, a first gear 21 is integrated with the shaft portion 20, and is engaged with a second gear 22 provided on the cassette 2. An end portion of a long plate-like first link 23 is rotatably linked to an outer circumferential portion of the second gear 22.

On the other end portion of the first link 23, there is formed a protrusion 23a which can be pressed by one end portion of an almost V-shaped second link 24 which is rotatably provided on the cassette 2 about a spindle 24a. Moreover, in the vicinity of the protrusion 23a, an coupling notch portion 23b is formed. With the coupling notch portion 23b, an coupling piece (unshown) rotatably provided on the cassette 2 is coupled. The coupling piece, which is rotated in forward and backward direction by driving of an unshown motor, disables the first link 23 from moving while it is coupled with the coupling notch portion 23b so as to maintain the rotor 16 in locked state.

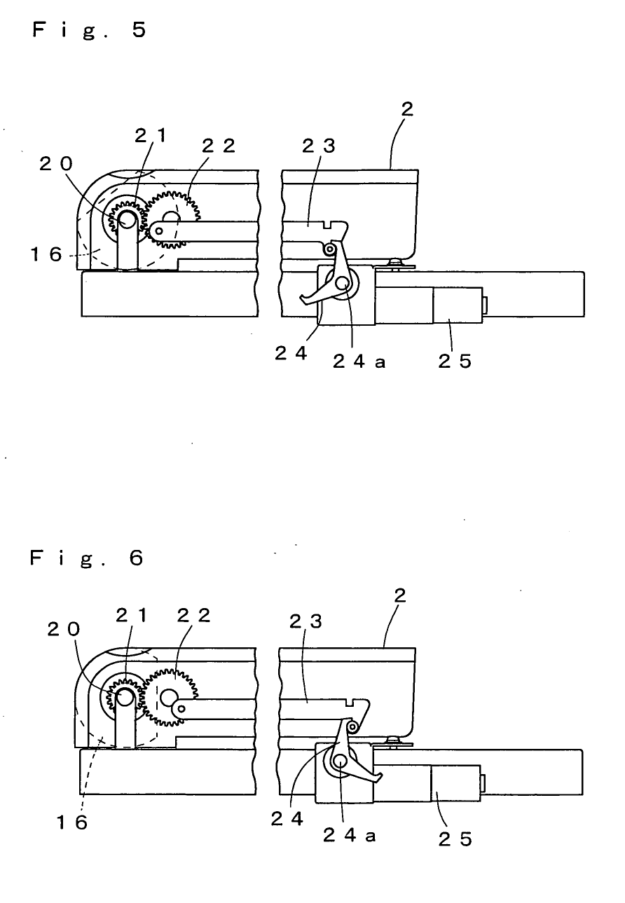

The second link 24 is driven to have backward and forward rotation based on driving force of a stepping motor 25 transmitted via a gear 25a. A magnet (unshown) is disposed on the spindle 24a at three locations and each magnet is detected by a sensor 26 so that the second link 24 (see FIG. 4A) can be stopped at a standby position (see FIG. 4A), an operating position (see FIG. 5), and a locked position (see FIG. 6), respectively. In the case where the second link 24 is positioned at the standby position, the rotor 16 is positioned, through the first link 23, the second gear 22 and the first gear 21, at a holding position for holding the medicine D in the cassette 2 in the holding recess portion 18 as shown by a dotted line in FIG. 4B. At this point, the recess portion 2a formed on the cassette 2 and the recess portion 16a formed on the rotor 16 are positioned to be continued, so that by getting the fingers caught in this continued portion, the cassette 2 can be pulled out from the stock shelf 1. When the second link 24 is rotated to the operating position shown in FIG. 5, the rotor 16 rotates, through the first link 23, the second gear 22 and the first gear 21, to an extraction position shown by a center line in FIG. 5, so that the medicine D held in the holding recess portion 18 can be extracted. When the second link 24 is rotated to the locked position shown in FIG. 6, the rotor 16 is disabled from rotating. Whether the medicine D is held in the holding recess portion 18 when the rotor 16 is rotated to the extraction position is detected by an unshown medicine detection sensor.

On the outer face of the rotor 16, as shown in FIGS. 3A and 3B, there are formed a support face 27a for supporting the next medicine D when the rotor 16 rotates while holding the medicine D in the holding recess portion 18, and a planar face 27b for sticking a label on which a medicine name is printed.

The outer shape of the rotor 16 is determined as follows. First, a column having a holding recess portion 18 large enough to be able to house a medicine D is assumed, with the center of its axis being aligned to the central position of the medicine D. Then, on the end face of the rotor 16, a shaft portion 20 is provided in a protruding manner so as to be positioned on the lower side of the center of the axis of the column and on its one end side (front side of the stock shelf 1). Then, a support face 27a is formed on a circle around the shaft portion 20. Further, a planar face 27b connected to the support face 27a is formed in a position which allows easy visual inspection from the front side when the rotor 16 is positioned at the holding position.

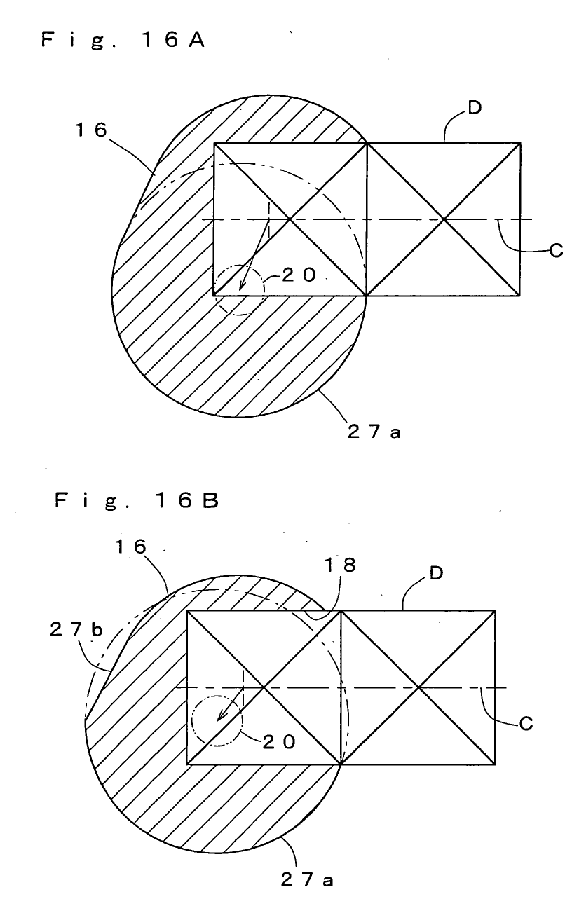

In the meantime, in order to prevent the track of the support face 27a when the rotor 16 is rotated from moving in forward and backward direction with respect to the next medicine D, the shaft portion 20 should preferably be positioned on the side as low as possible. As shown in FIG. 16A, if the shaft portion 20 is on the same plane as the lowermost portion of the medicine D, that is the bottom face of the cassette 2, then the next medicine D will not move forward and backward even when the rotor 16 rotates. However, if the shaft portion 20 is positioned on the lower side, in view of occupied space of the rotor 16, it is difficult to increase the scale of integration of the cassettes 2 which are disposed so as to be vertically stacked. Accordingly, in this embodiment, the shaft portion 20 is structured such that downward displacement with respect to a center C of the medicine D is suppressed and displacement toward the front side is increased.

Consequently, while the occupied space of the rotor 16 in vertical direction of the cassette 2 is suppressed, the track of the support face 27a which is generated when the rotor 16 rotates from the holding position to the discharge position (in the case where the medicine D is held in the holding recess portion 18 so as to slightly protrude from the holding recess portion 18 in consideration of interference between the rotor 16 and the next medicine D, the track of a corner portion of the medicine D held in the holding recess portion 18) is kept almost unchanged with respect to the array direction of the medicines D housed in the cassette 2, which allows suppression of dislocation of the next medicine D.

It is to be noted that when the rotor 16 rotates, friction force between the support face 27a and the next medicine D acts as force to lift the next medicine D, though the lid body 17 prevents the medicine D from floating up. Further, the shaft portion 20 of the rotor 16 should be provided so as to be displaced toward the support face 27a. For example, if the discharge direction of the medicines D is changed from the above-stated counterclockwise direction to clockwise direction, the shaft portion 20 should be displaced toward the upper front side.

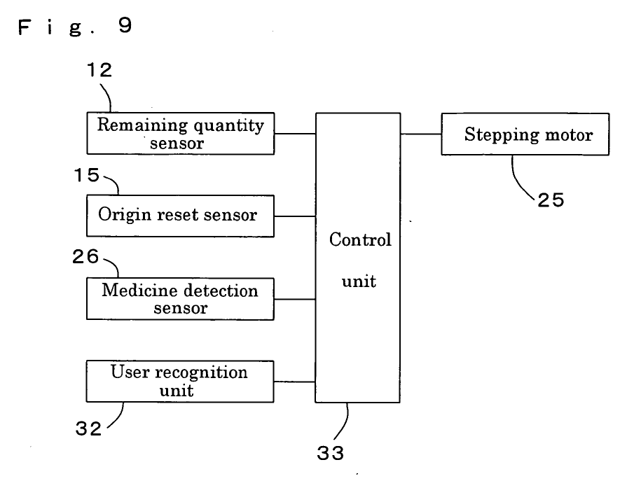

As shown in FIG. 9, in addition to input signals and processing data from the remaining quantity sensor 12, the origin reset sensor 15 and the medicine detection sensor 26, input signals of a user recognition unit 32 are also inputted into a control unit 33. The control unit 33 controls driving of the stepping motor 25 and the like in response to the input signals. The user recognition unit 32 can adopt various recognition means such as use of user IDs and passwords, finger print recognition and iris recognition. Only when a pre-registered person who is authorized to discharge medicines is recognized, the medicines D can be extracted by driving the stepping motor 25 and the like.

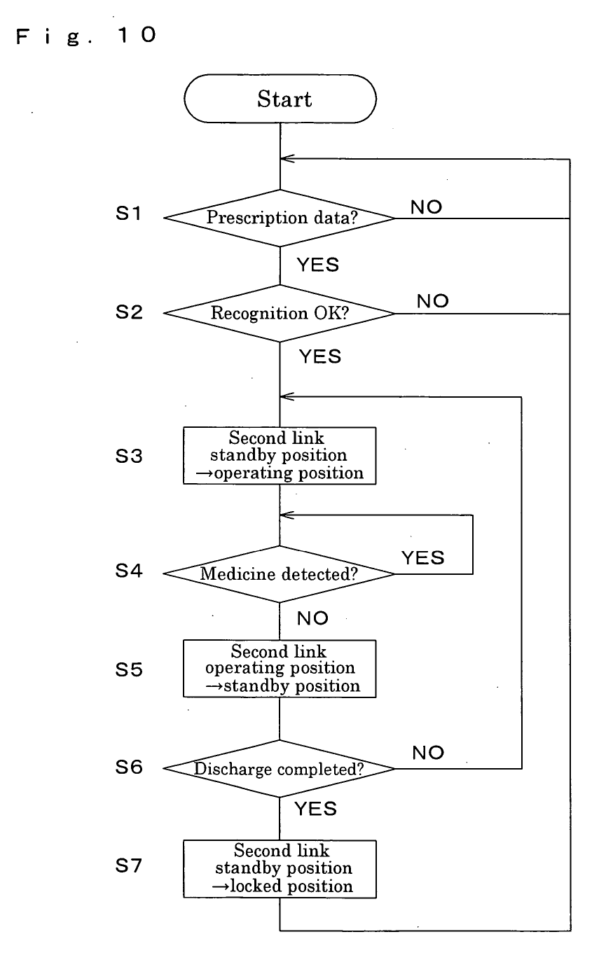

Description is now given of the operation of the above-structured medicine feeder with reference to the flow chart in FIG. 10. In the medicine feeder, medicines D are housed in each cassette 2 in the state of being arrayed in a row. In this state, biasing force of the constant-load spring 6 acts on the housed medicines D through the slide member 5, and a medicine D positioned in the forefront is held in the holding recess portion 18 of the rotor 16 positioned at the reception position.

If prescription data input is performed (step S1), and recognition in the user recognition unit 32 is properly performed (step S2), then based on the prescription data, the stepping motor 25 is driven for a predetermined period of time in the cassette 2 housing an appropriate medicine D, by which the second link 24 rotates to the operating position shown in FIG. 5 from the standby position shown in FIG. 4A (step S3). By this, the rotor 16 rotates from the reception position to the discharge position through the gear 25a, and the medicine D held in the holding recess portion 18 is moved to a dischargeable position on the front side. In this case, since the notch 19 is formed on the rotor 16, the medicine D can be grasped via the notch 19, thereby allowing easy extraction of the medicine D from the holding recess portion 18. At this point, it is detected whether or not the medicine D is extracted from the holding recess portion 18 based on the detection signal in the medicine detection sensor 26 (step S4), and if it is determined that the medicine D is extracted, then the stepping motor 25 is driven in backward direction to rotate the second link 24 from the operating position shown in FIG. 5 to the standby position shown in FIG. 4A (step S5), by which the rotor 16 is rotated to the reception position. Eventually, the next medicine D is held in the holding recess portion 18. Afterward, a specified quantity of medicines D are discharged in the same manner. After that, when discharge of a specified quantity of medicines is completed and the rotor 16 is rotated to the reception position (step S6), the second link 24 is rotated from the standby position shown in FIG. 4A to the locked position shown in FIG. 6 (step S7), by which the rotor 16 is disabled from rotating. As a result, it becomes impossible to rotate the rotor 16 from the outside to extract medicines D without permission. Therefore, even if the medicines to be handled are narcotics, dangerous drugs and the like, appropriate management is achievable without paying extra attention.

It is to be noted that a quantity of the medicines D housed in the cassette 2 is detected by the encoder 11 and the remaining quantity sensor 12, which makes it possible to perform specified display based on the detection signal and also to notify if the remaining quantity becomes low. In the step S3, it is also possible to rotate the rotor 16 in backward direction if a set time is passed without extraction of the medicine D from the holding recess portion 18 so as to prevent the medicine D from being left at the extraction position.

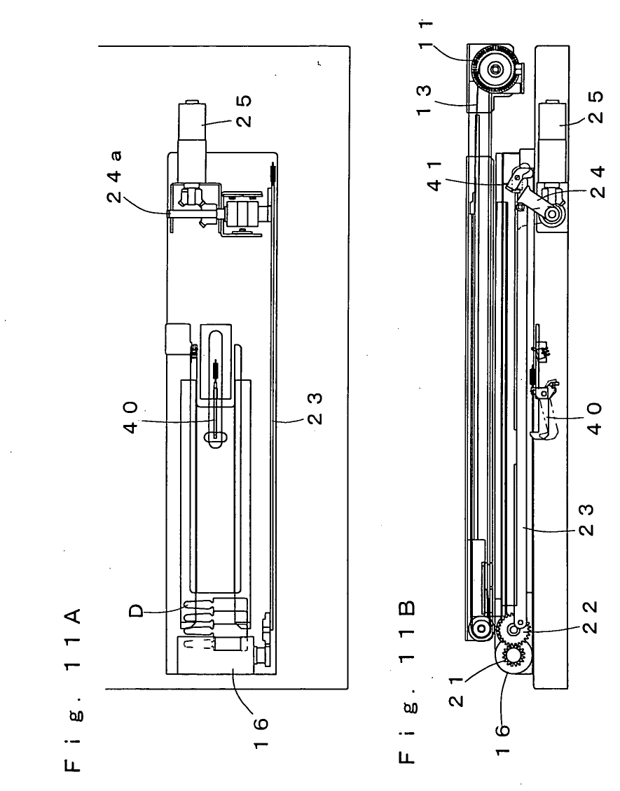

Further, the shape of the second link 24 is not limited to the above-stated almost V shape but may take an almost I shape shown in FIGS. 11A and 11B. In FIGS. 11A and 11B, a position shown by a solid line is the discharge position and a position shown by a dotted line is the locked position.

Further, although the first gear 21 is provided on the shaft portion 20 of the rotor 16 and is engaged with the second gear 22, the gears 21, 22 may be replaced with intermittent gears 40, 41 shown in FIG. 12. The intermittent gear 40 is structured such that on both sides of teeth portion 40a, release recess portions 40b, 40c are respectively formed in succession. The intermittent gear 41 is integrated with the guide plate 42, and sequential engagement of the gears 43 to 46 transmits driving force of a motor 47. The rotor 16 is rotated only when the teeth portions 40a, 41a of the intermittent gears 40, 41 are engaged. When the motor 47 is driven in forward direction to rotate the rotor 16 from the reception position to the discharge position, a circular portion 41b of the intermittent gear 41 slides through the release recess portion 40b to securely prevent further rotation. If the motor 47 is driven in backward direction, the teeth portions 40a, 41a of the intermittent gears 40, 41 are engaged again to rotate the rotor 16 from the discharge position to the reception position. Then, the circular portion 41b of the intermittent gear 41 slides through the release recess portion 40c of the intermittent gear 40, by which the rotor 16 is positioned at the reception position. Therefore, without high-precision management of the driving time of the motor 47, the rotor 16 can be securely positioned at both the discharge position and-the reception position. In addition, when the circular portion 41b is positioned at the release recess portions 40b, 40c, the rotor 16 is in locked state and cannot be rotated by operation from the outside.

Further, although the cassettes 2 are horizontally disposed so as to be stacked in vertical direction, they can also be disposed vertically or at a slant. This make it possible to arbitrarily change the shape of the stock shelf 1 according to installation space. For example, in the case where the installation space of the stock shelf 1 can be formed only on the lower side, the cassette 2 may be disposed vertically and the medicines D may be structured to be extracted from the upper face side. Further, the cassette 2 can be disposed sideways so that vials and the like are disposed with their lid sides facing upward.

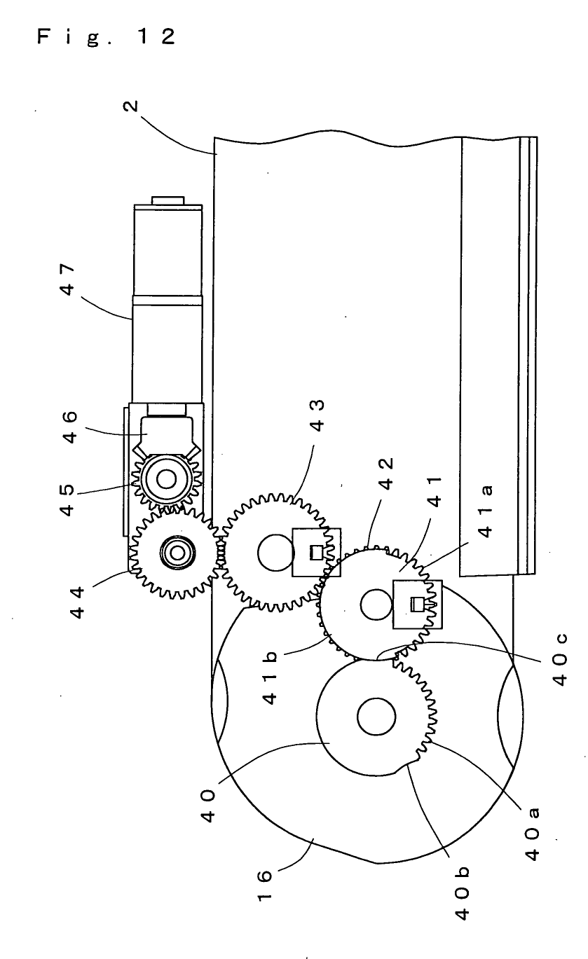

FIGS. 13A and 13B show an encoder in another embodiment. Herein, a disc-shaped encoder is replaced with a long plate-shaped encoder. More particularly, there is disposed an encoder 51 having a plurality of slits 50 formed at specified intervals in parallel with a slide shaft 52 extending from the front side to the back side. Moreover, a constant-load spring 53 and a position detection sensor 54 are slidably mounted on the slide shaft 52. A spring portion 53a of the constant-load spring 53 is fixed to the front side, and a slide member 55 integrated with the constant-load spring 53 presses the medicines D in the cassette 2 toward the front side. The position detection sensor 54 detects the slits 50 of the encoder 51, and its detection signal is used to identify the position of the slide member 55, i.e., a quantity of the medicines D in the cassette 2.

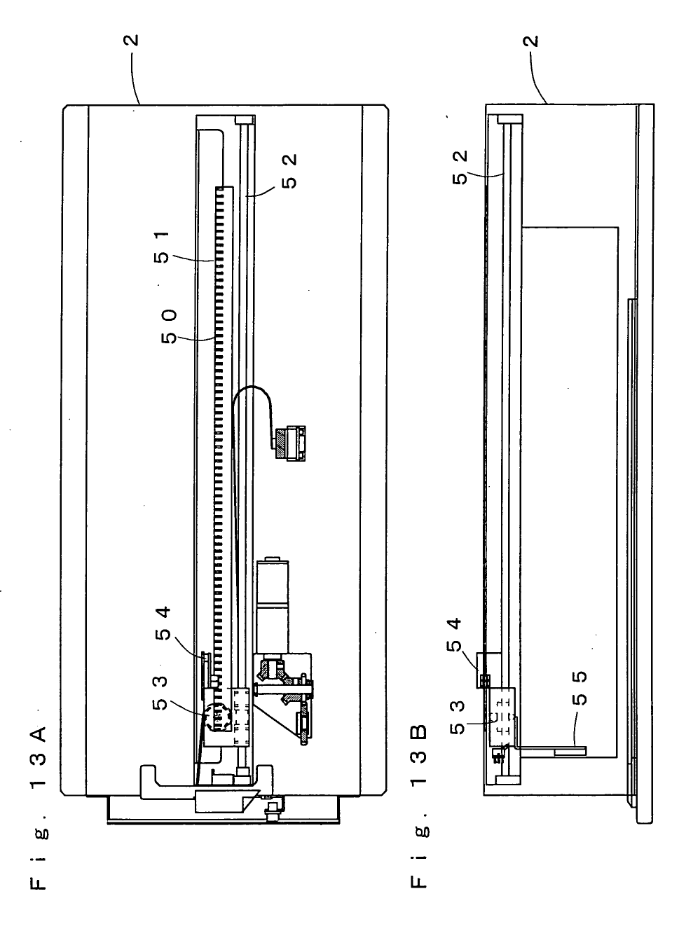

FIG. 14 shows a rotational driving mechanism of a rotor 16 in another embodiment. In the rotational driving mechanism, a pinion 60 is reciprocally moved in backward and forward direction (longitudinal direction in FIG. 14) by an unshown solenoid and the like, by which a rack 61 is rotated so as to position the rotor 16 (herein unshown) at the reception position and the discharge position, respectively, through a link 63 against biasing force of a spring 62.

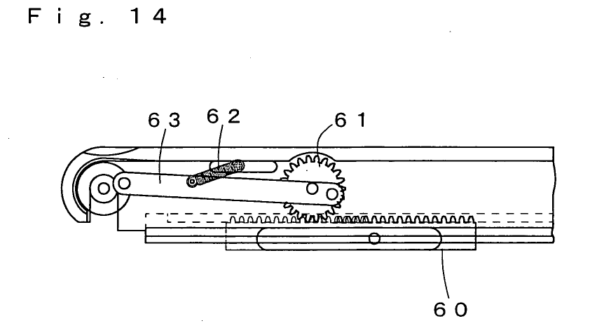

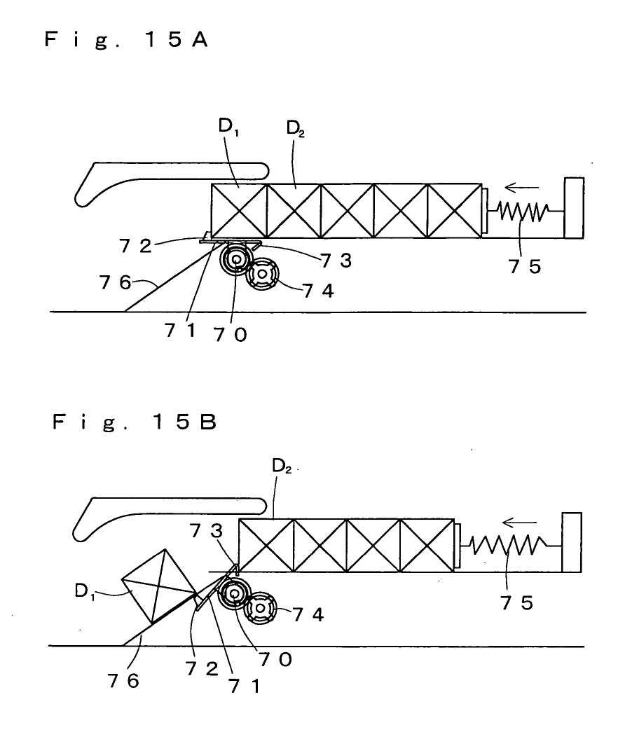

FIGS. 15A and 15B show a discharge mechanism in another embodiment. In this discharge mechanism, a discharge plate 71 rotatable around a spindle 70 is provided instead of the rotor 16. On one edge of the discharge plate 71, a first coupling portion 72 which couples with a medicine D1 positioned in the forefront is formed, while on the other edge of the discharge plate 71, a second coupling portion 73 which can support the next medicine D2 is formed. The discharge plate 71 rotates through a gear 74 by driving of an unshown motor. The medicines D in the cassette 2 are biased toward the front side by a spring 75 provided on the back side, and an inclined plate 76 is provided at the discharge position on the front side.

In such a discharge mechanism, for discharging the medicines, an unshown motor is driven to rotate the removing portion 71 counterclockwise as shown in FIG. 15B. Consequently, the coupling state by the d72 is cancelled, and the medicine D1 positioned in the forefront slides down the inclined plate 76. At this point, the second coupling portion 73 couples with the next medicine D2, which makes it possible to reliably discharge only the medicine D1 in the forefront.

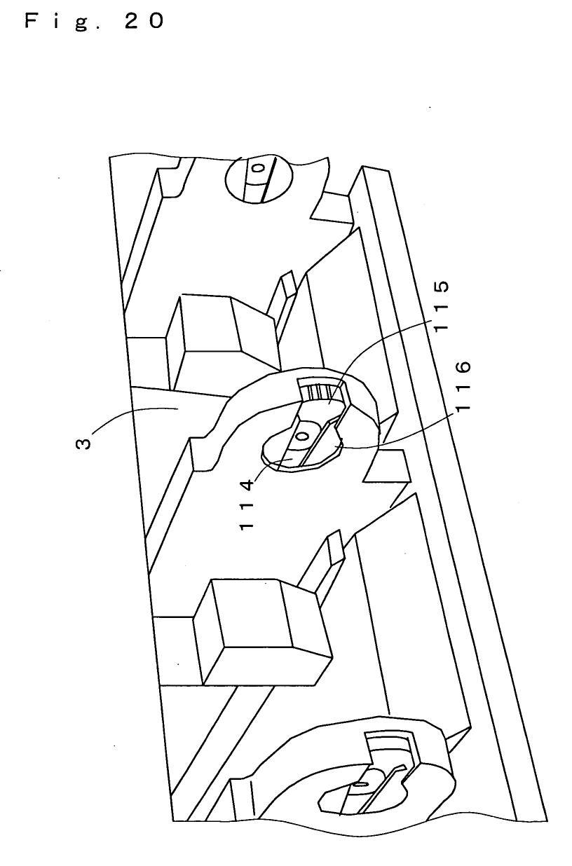

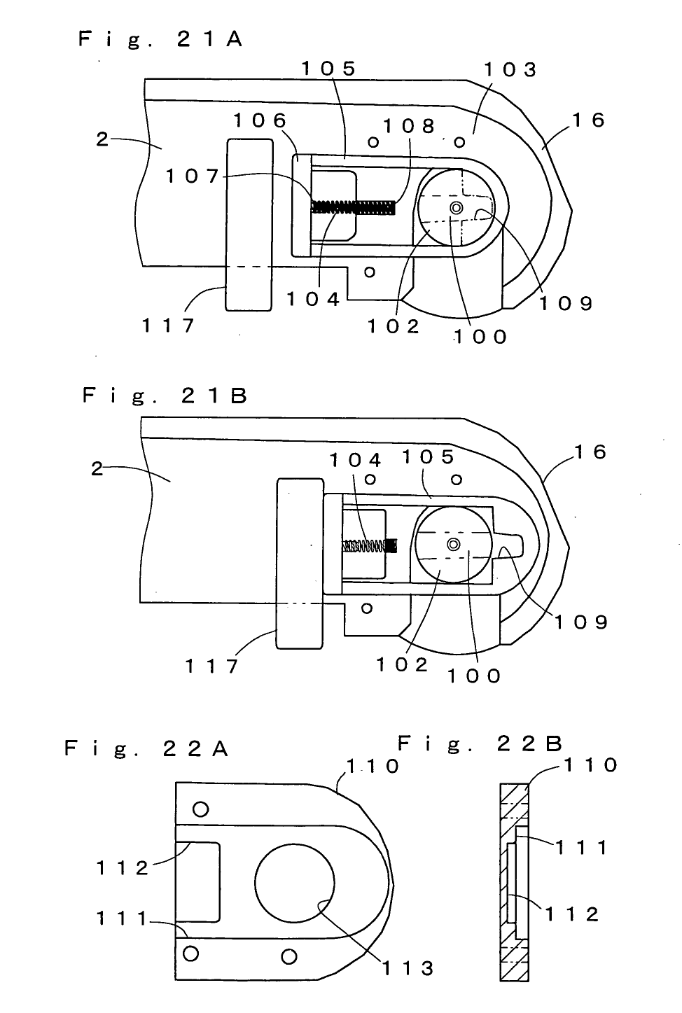

FIG. 17 to FIG. 22 show a rotational driving mechanism of a rotor 16 in still another embodiment is shown. In the rotational driving mechanism, on a shaft portion 20 protruding from the central section on both the end faces of a rotor 16 provided on a cassette 2, discs 101, 102 having a guide protruding portion 100 are provided respectively. On the side of the disc 102, a lock member 103 shown in FIGS. 21A and 21B is provided. The locking member 103 has a lock frame 105 biased toward the left side in the figure. In an indentation portion 106 on one end side of the lock frame 105, a protrusion 107 is formed on the inner face side, and the protrusion 107 and a groove portion 108 formed on the side face of the cassette 2 hold the spring 104. On the other end portion of the lock frame 105, there is formed an coupling groove 109 which couples with and uncouples from the guide protruding portion 100 on the disc 102. The spring 104 and the lock frame 105 are covered with a cover 110 fixed to the cassette 2 except the indentation portion 106. On the cover 110, there are formed a slide groove 111 through which the lock frame 105 slides, a first release recess portion 112 through which the indentation portion 106 can slide, and a second release recess portion 113 through which the disc 102 can rotate. Further, on the side of each housing portion 3 in the stock shelf 1, the intermittent gear 40 shown in FIG. 12 is replaced with a driving gear 115 having an coupling groove 114 on its central section as shown in FIG. 20, the driving gear 115 being coupled with and uncoupled from the guide protruding portion 100. The structure excluding the intermittent gear 40 is identical to that shown in FIG. 12. On one side wall constituting the housing portion 3, a notch portion 116 is formed so that the coupling groove 114 of the driving gear 115 is exposed. Consequently, when the cassette 2 is mounted on the housing portion 3, the guide protruding portion 100 can couple with the coupling groove 114. It is to be noted that by mounting of the cassette 2, a contact portion 117 with which the indentation portion 106 of the lock frame 105 comes into contact is formed on the side face of the housing portion 3.

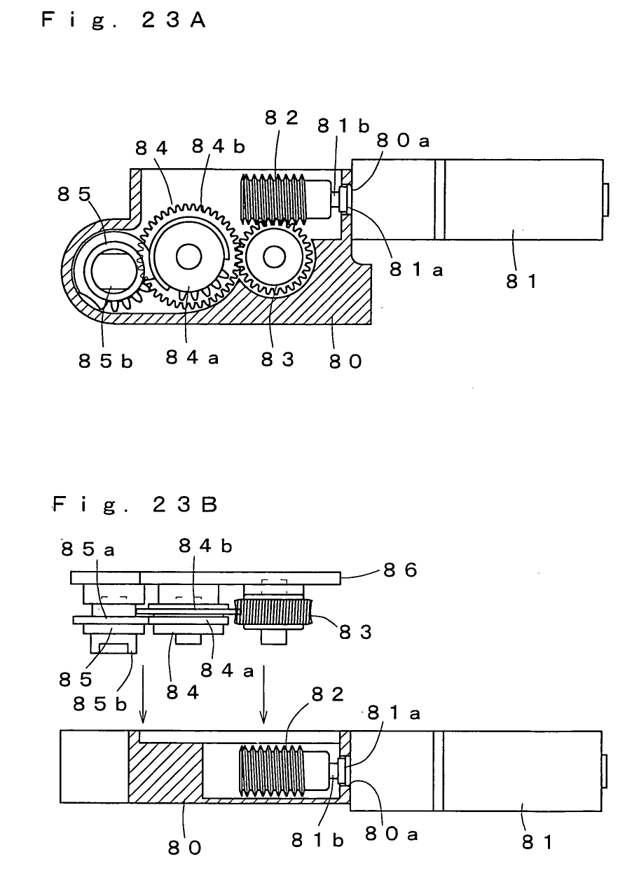

FIGS. 23A and 23B show an example of the rotational driving mechanism of a rotor 16 in still another embodiment. The rotational driving mechanism is provided on a casing 80 attached to each housing portion 3 in the stock shelf 1, and driving force of a motor 81 is transmitted to a driving gear 85 through a worm gear 82, a worm wheel 83 and an intermediate gear 84.

The top face and the side face of the casing 80 are open and the side face is closed by a cover 86. On one end face of the casing 80, a through hole 80a is formed, and a bearing portion 81a of the motor 81 is fixed to the through hole 80a. The worm gear 82 is fixed to a spindle 81b protruding from the bearing portion 81a of the motor 81 and is disposed in the casing 80. The worm wheel 83, the intermediate gear 84 and the driving gear 85 are rotatably mounted on the cover 86. The intermediate gear 84 has a structure integrated with an intermittent gear 84a and a spur gear 84b, and the spur gear 84b is engaged with the worm wheel 83 while the intermittent gear 84a can engage with the driving gear 85. An intermittent gear is used in the driving gear 85, and on the top end face of the driving gear 85, a guide piece 85b protruding at a specified interval is formed. In the state that the cover 86 is attached to the casing 80 with a screw and the like, the worm wheel 83, the intermediate gear 84 and the driving gear 85 are positioned in the casing 80, with the worm wheel 83 engaging with the worm gear 82.

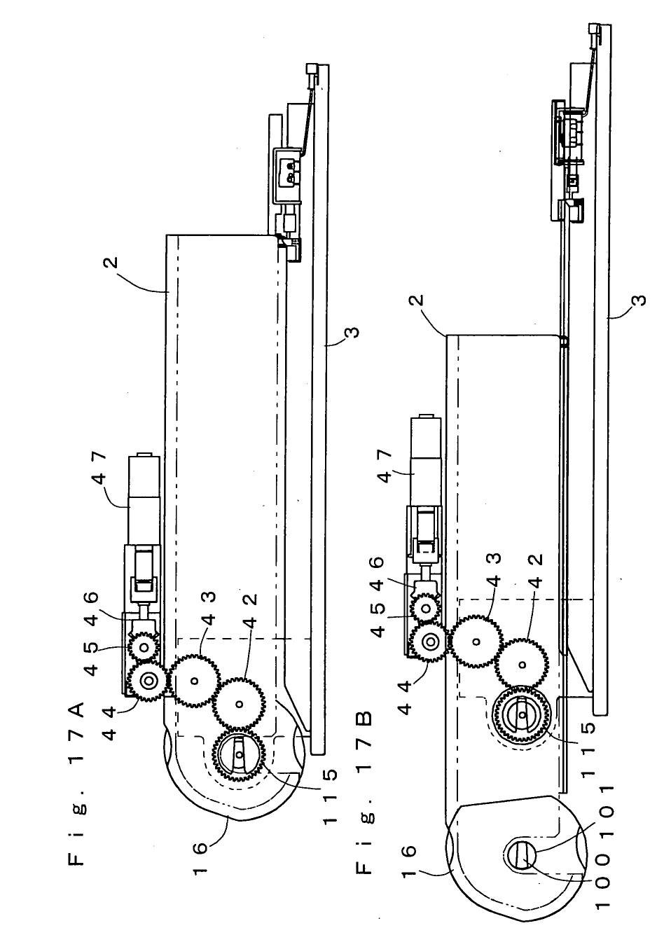

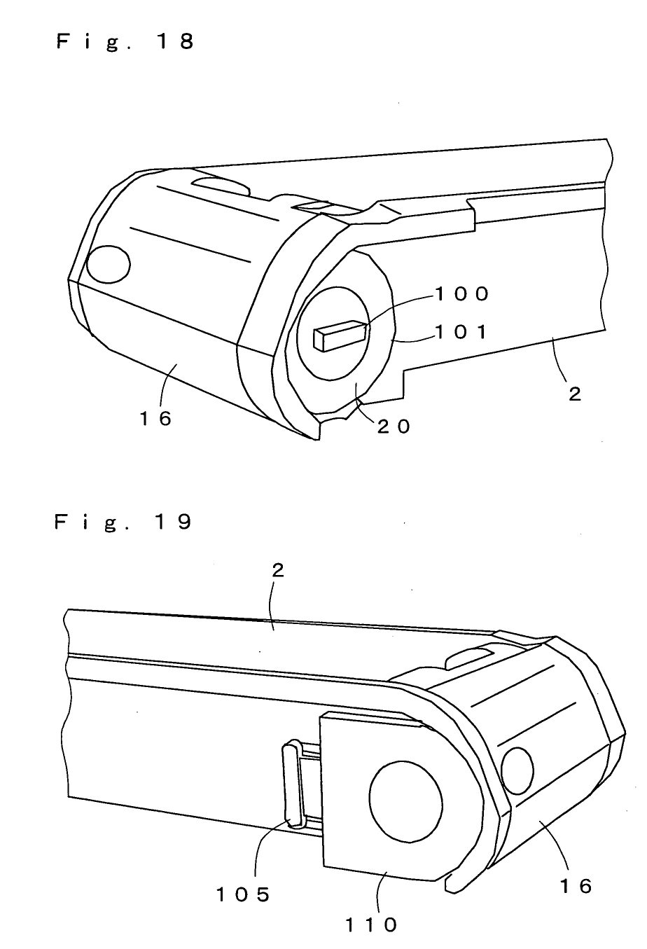

The cassette 2 housed in the housing portion 3 has a rotor 16 on one end side as with the structure shown in the above-described FIG. 18, and on one side of a shaft portion 20 protruding from both end portions of the rotor 16, a guide protruding portion 100 guided by the guide piece 85b of the driving gear 85 is formed.

In the housing portion 3 having the above-structured rotational driving mechanism, when the cassette 2 is mounted, the guide protruding portion 100 protruding from the rotor 16 is guided to the guide piece 85b of the driving gear 85. As a result, by driving the motor 81 to have forward and backward rotation, power transmitted to the driving gear 85 is transmitted to the rotor 16 through the shaft portion 20 as with the case shown in the previous FIG. 12. Then, the rotor 16 rotates to the discharge position and the reception position, so that the medicines D housed in the cassette 2 are discharged in sequence. In this case, if the rotor 16 rotates to a specified position, a teeth portion of the intermittent gear 84a of the intermediate gear 84 does not engage with a teeth portion of the driving gear 85 so that further rotation is prevented. Therefore, without high-precision management of the driving time of the motor 81, the rotor 16 can be securely positioned at both the discharge position and the reception position.

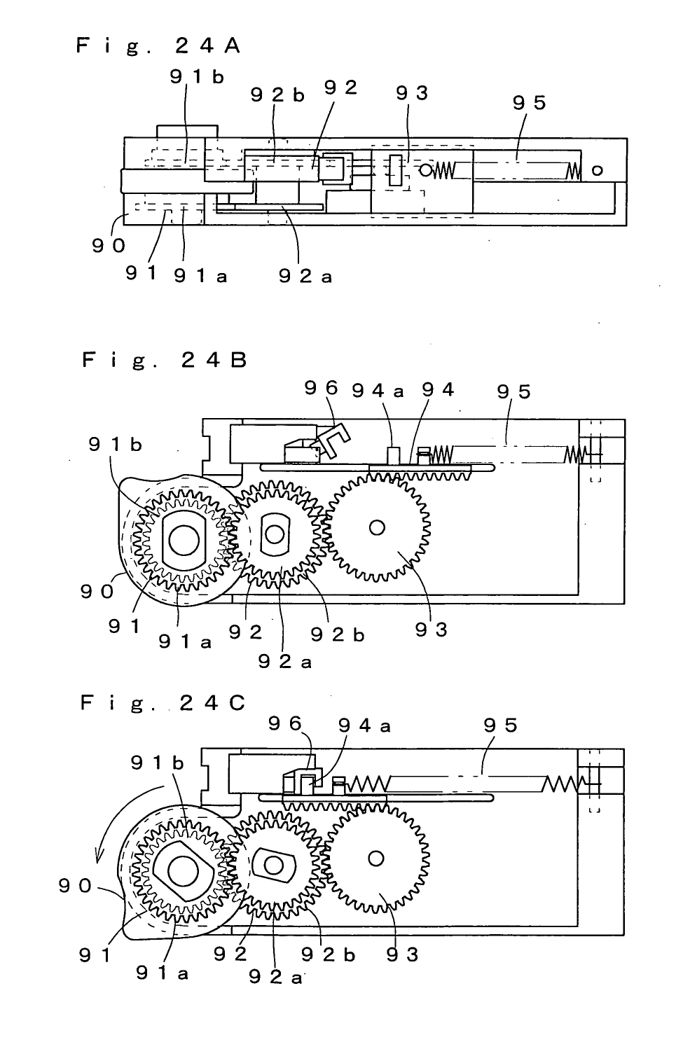

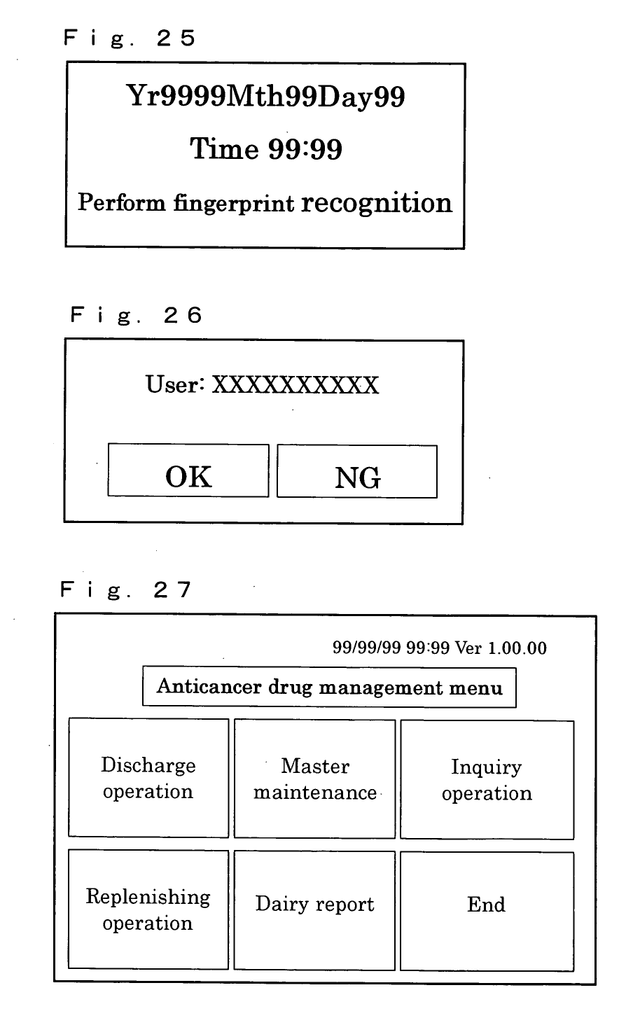

FIGS. 24A, 24B and 24C show an example of the rotational driving mechanism of a rotor 16 in still another embodiment. The rotational driving mechanism is provided on each housing portion 3 in the stock shelf 1, and has a torque transmission member 90. When the cassette 2 is housed in the housing portion 3, a shaft portion 20 of a rotor 16 provided on one end portion of the cassette 2 couples with the torque transmission member 90 so as to rotate integrally. Also, the torque transmission member 90 is integrated with a first gear 91, and a slider 94 is interlocked with a second gear 92 and a third gear 93. The first gear 91 is formed by integrating spur gears 91a, 91b. The second gear 92 is formed by integrating spur gears 92a, 92b each engaged with the spur gears 91a, 91b of the first gear 91. The spur gear 92a engages with a gear provided on an spindle of an unshown motor, while the spur gear 92b engages with the third gear 93. The slider 94 is biased in a direction away from the rotor 16 by biasing force of a spring 95. An coupling protruding portion 94a is formed on the slider 94, and a latch 96 is coupled with the coupling protruding portion 94a so that the rotor 16 is positioned at the discharge position shown in FIG. 24C. Further, a damper 97 is provided on the third gear 93 for alleviating rapid rotation caused by biasing force of the spring 95 when the latch 96 is released.

In the housing portion 3 having the above-structured rotational driving mechanism, when the cassette 2 is mounted thereon, the rotor 16 couples with the torque transmission member 90. Consequently, an unshown motor is driven to have rotation in forward and backward direction, and the rotor 16 rotates through the torque transmission member 90 so as to be positioned at the discharge position or the reception position, by which the medicines D housed in the cassette 2 are discharged singly. When the rotor 16 is in the state of being rotated to the discharge position, the first gear 91, the second gear 92 and the third gear 93 rotate and the slider 94 moves to a position shown in FIG. 24C. Then, at this position, the latch 96 couples with the coupling protruding portion 94a. As a result, the slider 94 is disabled from moving, and the torque transmission member 90, i.e., the rotor 16, is positioned at the discharge position through the third gear 93, the second gear 92 and the first gear 91. If the coupling state by the latch 96 is cancelled, the slider 94 moves to a position shown in FIG. 24B by biasing force of the spring 95, so that the third gear 93 rotates. At this time, by virtue of the damper 97, rapid rotation of the third gear 93 is prevented. Therefore, the rotational velocity of the torque transmission member 90 which rotates through the second gear 92 and the first gear 91 is suppressed, and so the rotor 16 smoothly returns to the reception position.

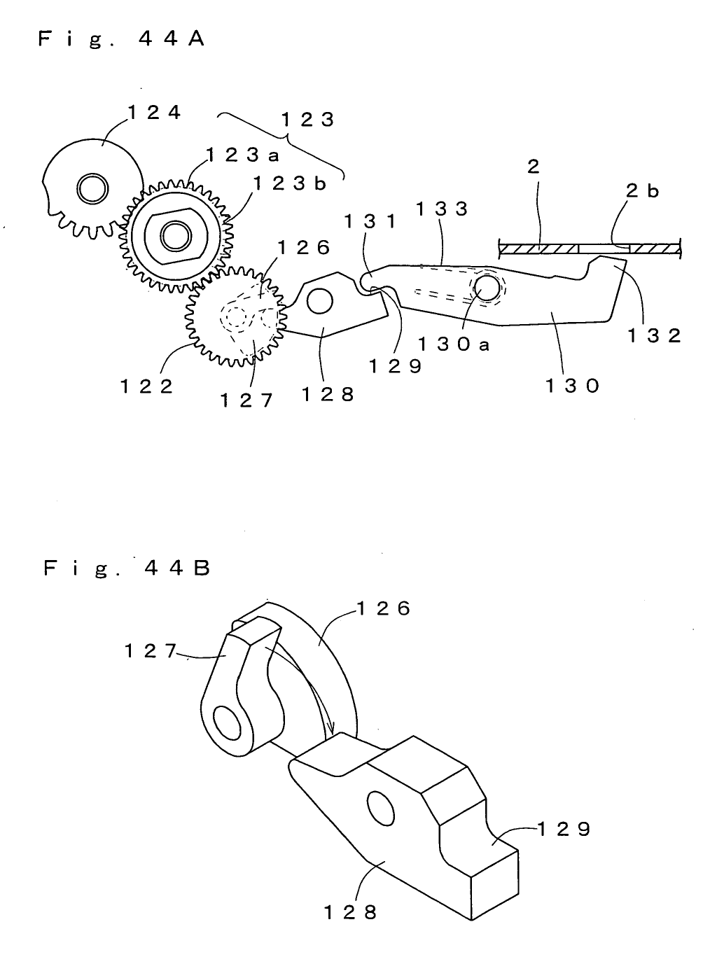

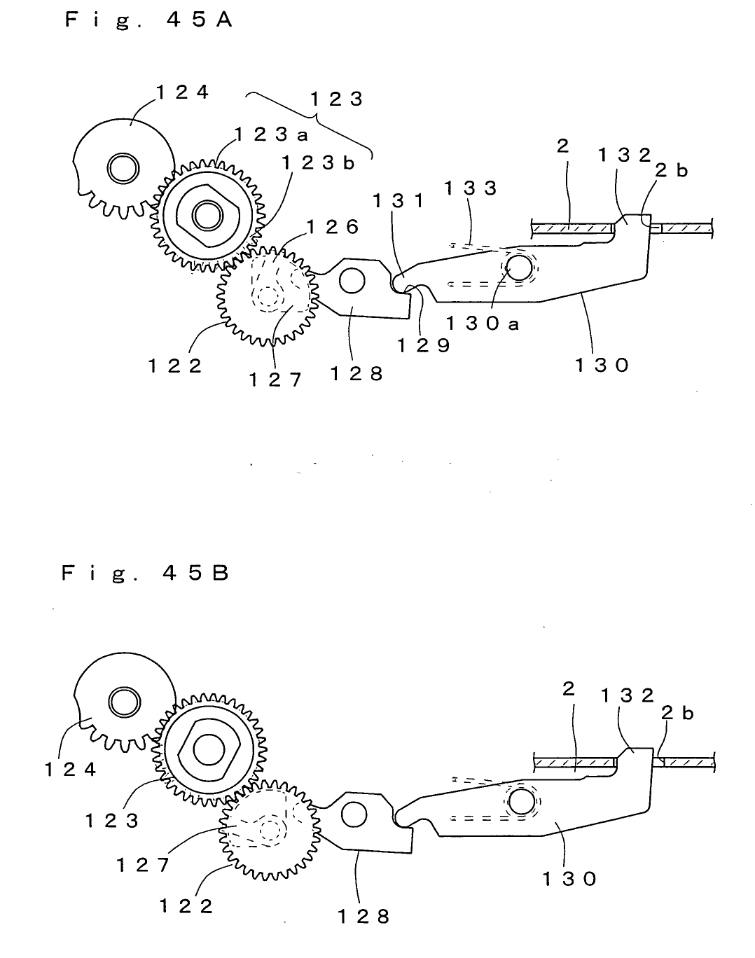

FIGS. 43 to 45 show an example of the rotational driving mechanism of a rotor 16 in still another embodiment. The rotational driving mechanism is provided in each housing portion 3 in the stock shelf 1. In the state that the cassette 2 is mounted on the housing portion 3, driving force of a motor 120 is transmitted from a driving gear 121 provided on its spindle 120a to a driven gear 124 provided on a shaft portion of the rotor 16 through a first intermediate gear 122 and a second intermediate gear 123, by which the rotor 16 is rotated. The first intermediate gear 122 is provided on one end portion of a shaft member 125, and a cam 126 is attached to the other end portion of the shaft member 125. The cam 126 has a pressing piece 127 and rotates around the shaft member 125 so that the pressing piece 127 presses one end portion of a first link 128, which is rotated around a spindle 128a. The first link 128 has a connecting recess portion 129 in one end portion, and on the connecting recess portion 129, a connecting portion 131 formed on one end side of a second link 130 which is rotatably provided around a spindle 130a is slidably positioned. On the other end portion of the second link 130, an coupling portion 132 is formed, and the coupling portion 132 can be coupled with an coupling hole 2b formed on the bottom face of the cassette 2. The second link 130 is biased counterclockwise in FIG. 4A by a spring 133 externally mounted on the spindle 130a. The first intermediate gear 122 is formed by integrating a first gear 122a formed from a helical gear and a second gear 122b formed from a spur gear. The first gear 122a engages with the driving gear 121. The second intermediate gear 123 is formed by integrating a first gear 123a formed from a spur gear which is engaged with the first gear 122a of the first intermediate gear 122 and a second gear 123b formed from an intermittent gear. The driven gear 121 is formed from an intermittent gear similar to the second gear 123b of the second intermediate gear 123, and operates with the intermediate gear 123 only in the range of a specified angle at which the second intermediate gear 123 rotates to rotate the rotor 16. The structure for rotating the rotor 16 by using an intermittent gear is similar to that shown in the previous FIG. 12.

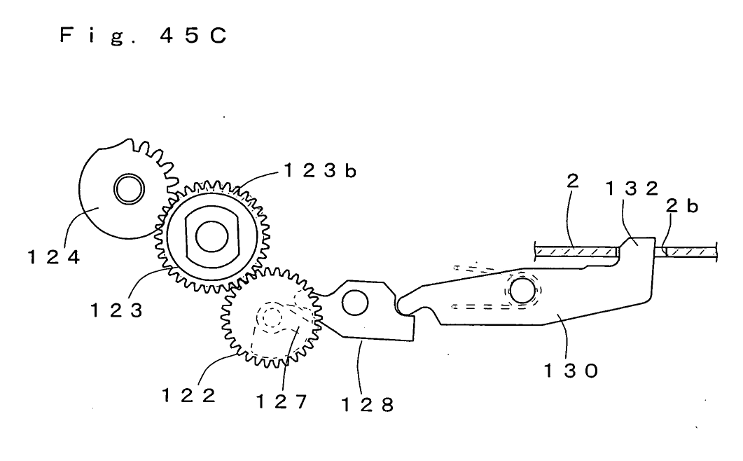

If the cassette 2 having the above-structured rotational driving mechanism is mounted on the housing portion 3, the coupling portion 132 of the second link 130 is coupled with the coupling hole 2b of the cassette 2 as shown in FIG. 45A. Also in the rotor 16, the driven gear 121 is partially engaged with the second gear 123b of the second intermediate gear 123, which prevents rotation by manual operation.

In the case of discharging medicines from the cassette 2, the motor 120 is driven in forward direction so as to rotate the rotor 16 through each of the gears 121, 122, 123 and 124. The driving of the motor 120 in forward direction rotates the first intermediate gear 122 counterclockwise, by which the driven gear 124 rotates from a position shown in FIG. 45B to a position shown in FIG. 45C. As a result, the rotor 16 is rotated from the reception position at which the medicine in the cassette 2 can be held in the holding recess portion 18 to the discharge position for discharging the medicines from the cassette 2. Consequently, the medicine held in the holding recess portion 18 of the rotor 16 is discharged. In this state, the pressing piece 127 of the cam 126 comes into contact with one end portion of the first link 128, which prevents the first link 128 from rotating. Therefore, the coupling portion 132 of the second link 130 maintains the coupling state with the coupling hole 2b of the cassette 2, which securely prevents the cassette 2 from falling from the housing portion 3 while discharge operation of the medicines.

When discharge of the medicines is completed, the motor 120 is driven in backward direction to rotate the rotor 16 from the discharge position to the reception position.

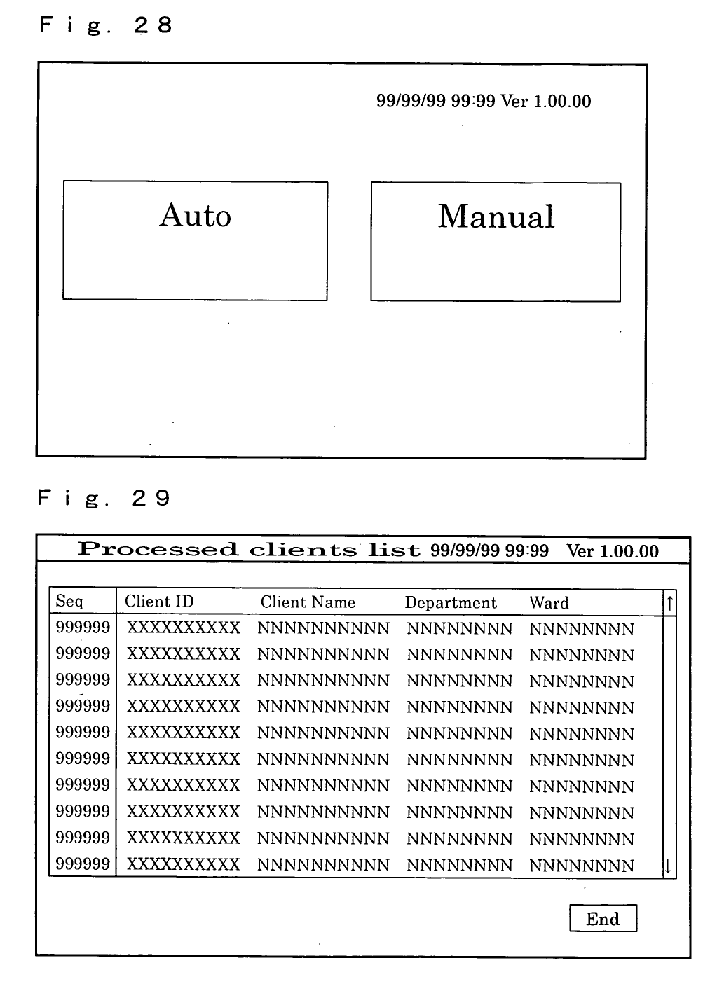

FIG. 25 to FIG. 42 show examples of display on an operation display panel 200. FIG. 25 shows a fingerprint recognition screen in the step S2. When the fingerprint recognition is performed, the display is switched to the screen shown in FIG. 26, and if OK button is selected, the display shifts to a various operations screen shown in FIG. 27, while if NG button is operated, the display returns to the fingerprint recognition screen.

In the various operations screen, there is displayed an anticancer drug management menu including a discharge operation button, a master maintenance button, an inquiry operation button, a replenishing operation button, a daily report button and an end button.

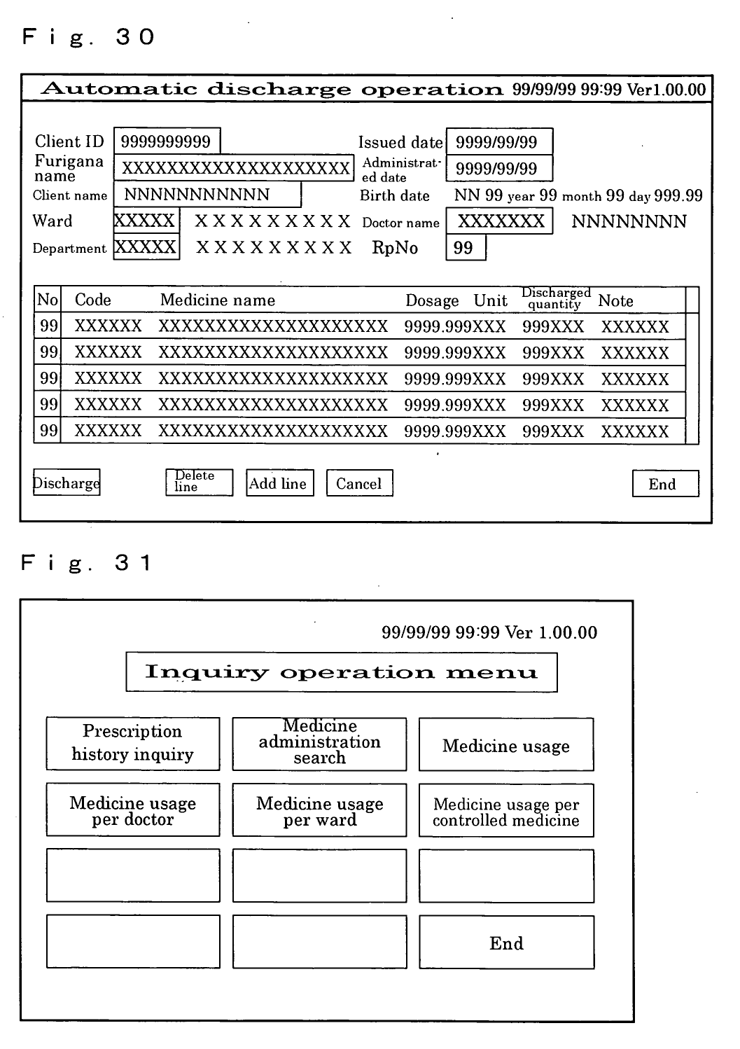

When the discharge operation button is operated, the display is switched to an auto/manual screen shown in FIG. 28. If the auto button is operated, the display is switched to a processed clients list screen shown in FIG. 29, and automatic medicine discharge processing is started.

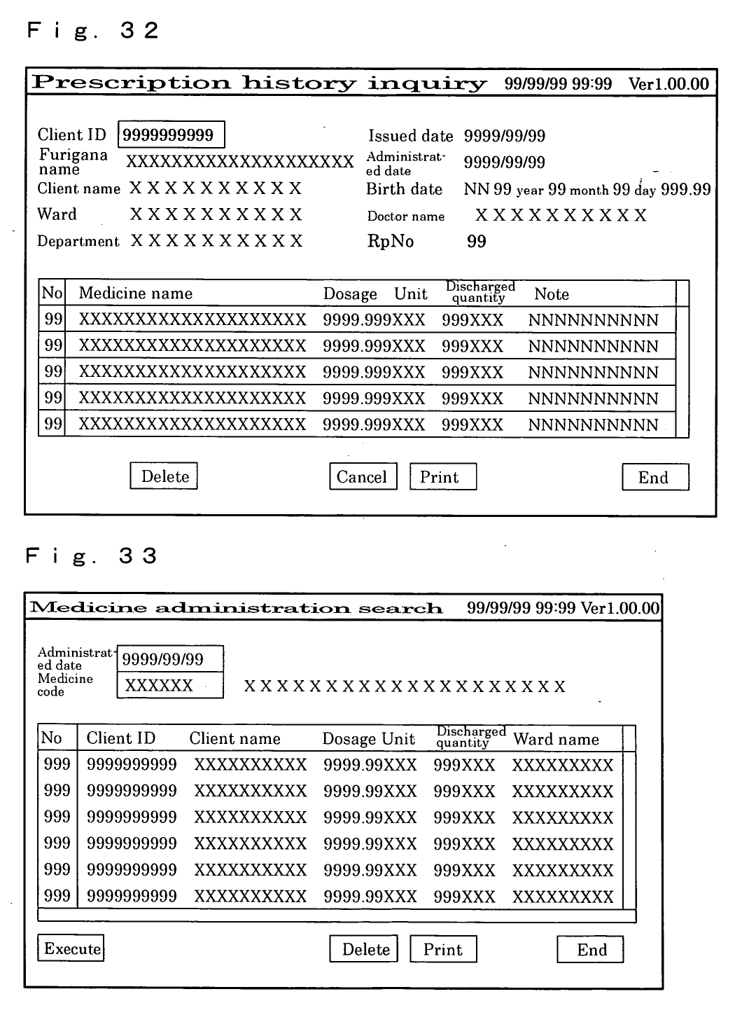

In the processing clients list screen, prescription data is read, and client IDs, client names, departments and wards of the clients with unprocessed prescription are automatically displayed. By selecting a desired line, the display is switched to a discharge operating screen shown in FIG. 30, and information on a selected client (client ID, issued date, etc.) and the entire prescription details of the client are displayed. In this screen, a discharge quantity and the like are checked, and operations including addition, deletion and modification are performed. When the discharge button is operated, each line on the screen is displayed in reverse video in sequence from the top line and discharge processing is started.

In the discharge processing, inventory information on the cassette 2 housing an appropriate medicine is checked and if the medicine is out of stock, then a message thereof is displayed and the data is stored as unfinished information before inventory check for the next medicine is started. If the medicine is in supply, then discharge is started, and in the line of the pertinent medicine on the discharge operation screen, a status report for reporting the progress of the medicine discharge is displayed (e.g., showing a bar chart indicating the percentages of accomplishment). On the screen, the line that the discharge processing is completed is displayed in red, the line during discharge processing is displayed in green, and the line that the discharge processing is unfinished is displayed in white. It is to be noted that if the manual button is operated on the auto/manual screen, the display is directly switched to the processing clients list screen, and after pertinent data is inputted in each item, the same processing is performed.

In the case where the discharge processing is interrupted during the processing, e.g., the case where by a weight sensor, a specified time is passed after an operator is away from the medicine feeder, or the case where the feeder is stopped due to errors and the like, the display is returned to an initial screen and processing is continued only when the fingerprint recognition is performed again. Further, in the case where an operator wants to perform the processing later, operating an unshown suspension button allows suspension of the processing. In this case, as with the case of interruption, the processing is restarted only when the fingerprint recognition is performed again. It is to be noted that in the case of interruption, if an operator is the same person, the previously interrupted processing is forcedly restarted (the display returns to the interrupted screen).

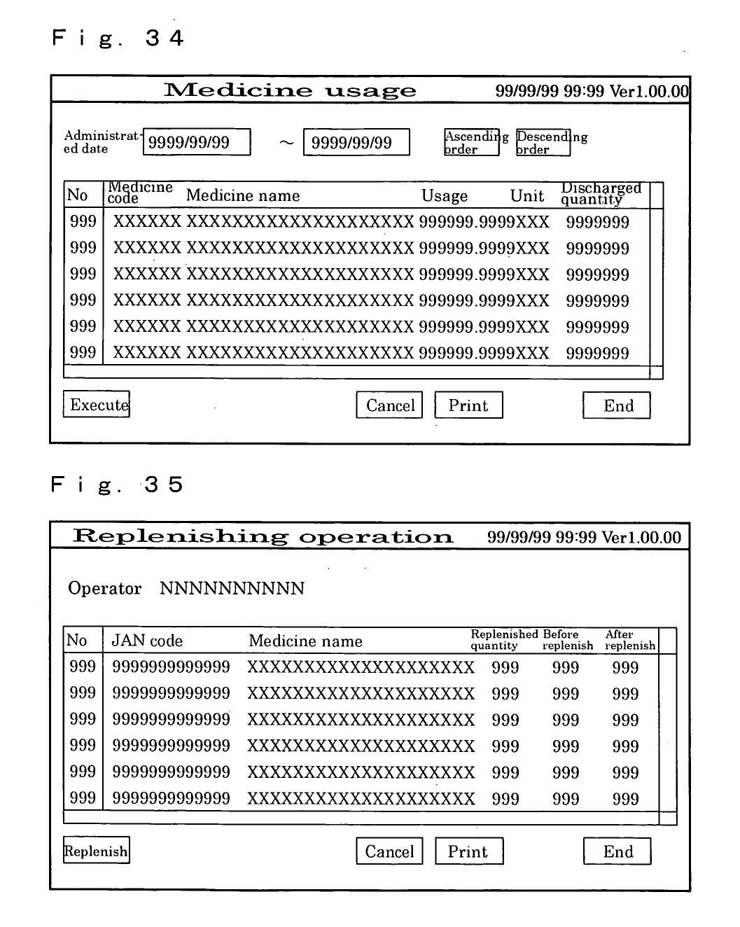

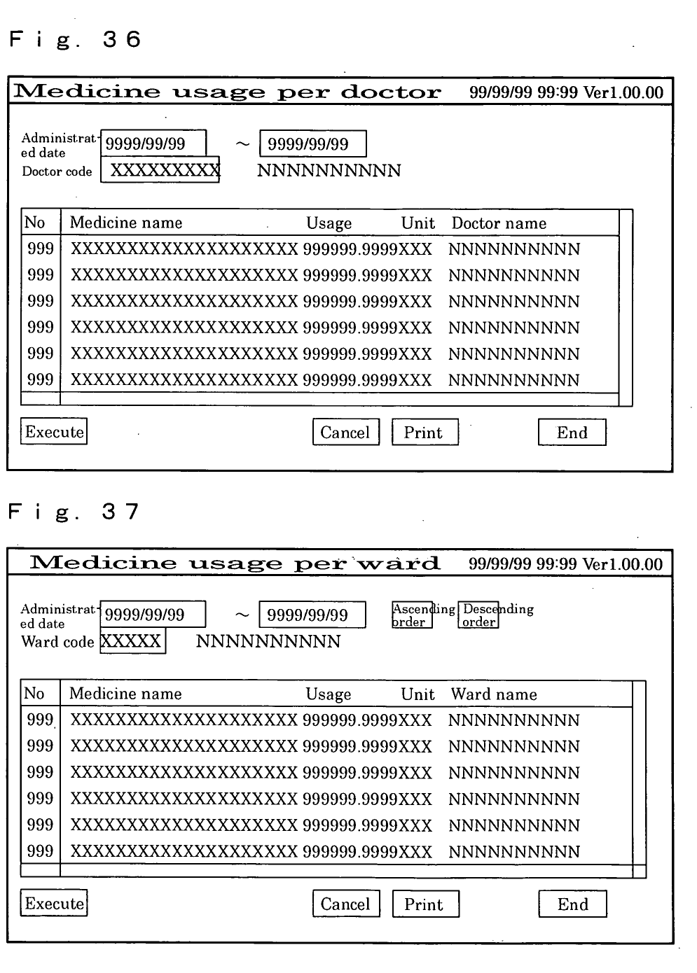

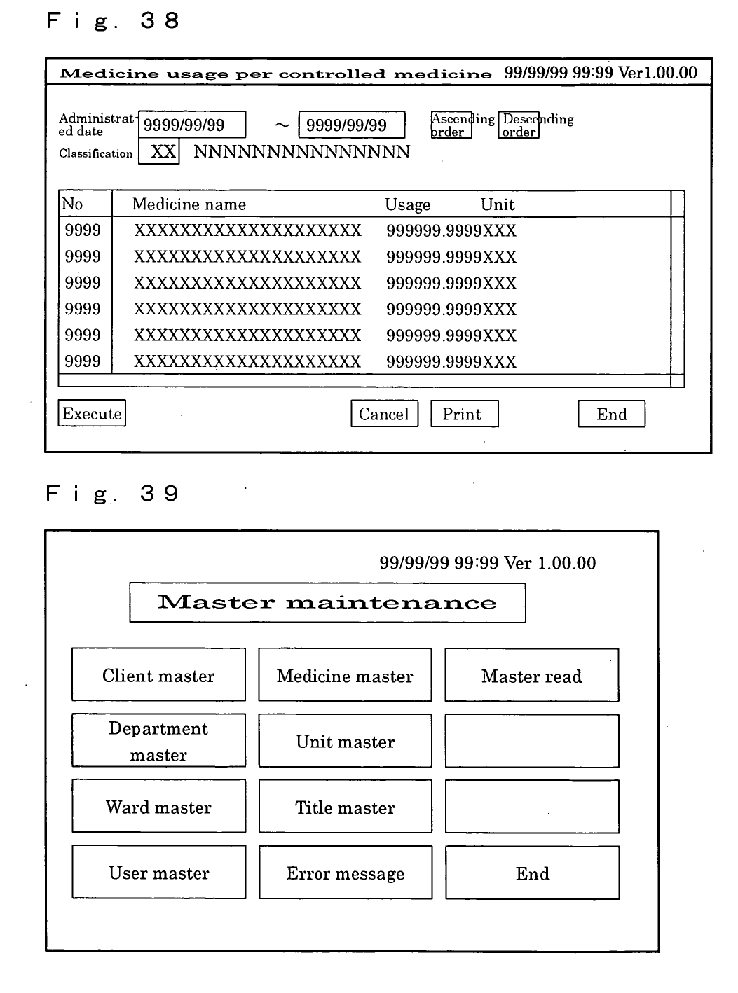

When the inquiry operation button is operated, the display is switched to an inquiry operation menu screen shown in FIG. 31, where a prescription history inquiry button, a medicine administration search button, a medicine usage button, a medicine usage per doctor button, medicine usage per ward button, a medicine usage per controlled medicine button and an end button are displayed. By operating the prescription history inquiry button, a prescription history inquiry screen shown in FIG. 32 can be displayed and the prescription history can be inquired. By operating the medicine administration search button, a medicine administration search screen shown in FIG. 33 can be displayed and used for checking the inventory when inventory figures are questionable. By operating the medicine usage button, a medicine usage screen shown in FIG. 34 can be displayed and a list of medicine usage by administration date can be indicated. By operating the medicine usage per doctor button, a medicine usage per doctor screen shown in FIG. 36 can be displayed to confirm which doctors use which medicines for how much quantity. By operating the medicine usage per ward button, a medicine usage per ward screen shown in FIG. 37 can be displayed to confirm usage of medicines per ward. By operating the medicine usage per controlled medicine button, the medicine usage per controlled medicine screen shown in FIG. 38 can be displayed to check the medicines required to be controlled such as psychotropic drugs by each medicine.

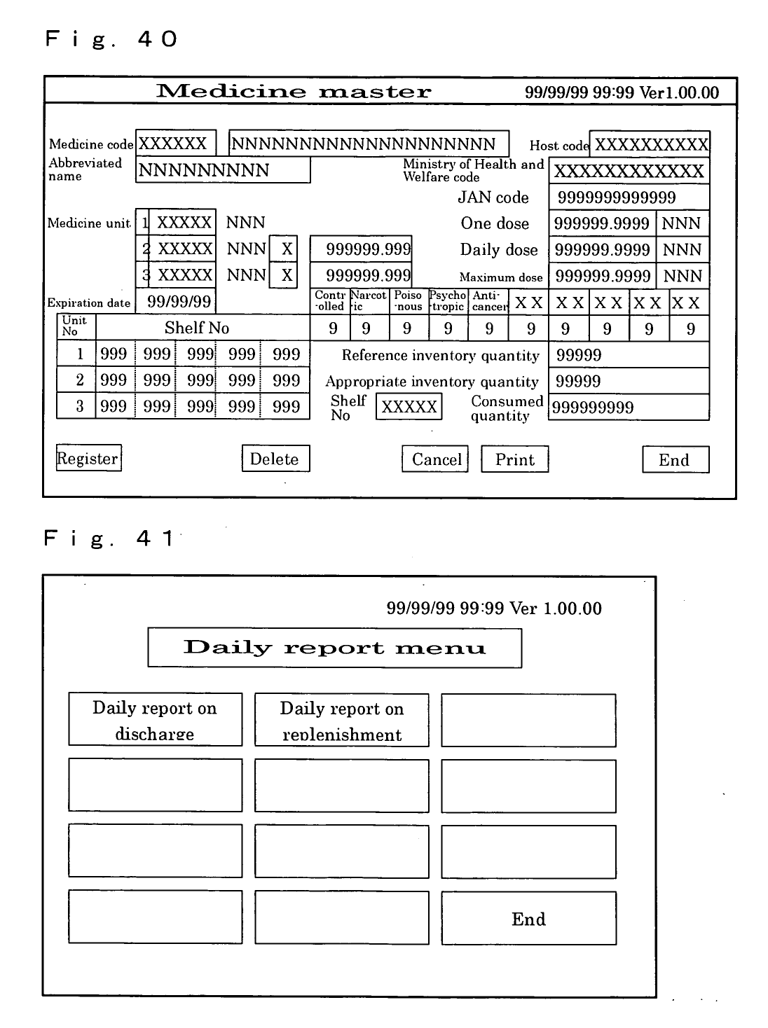

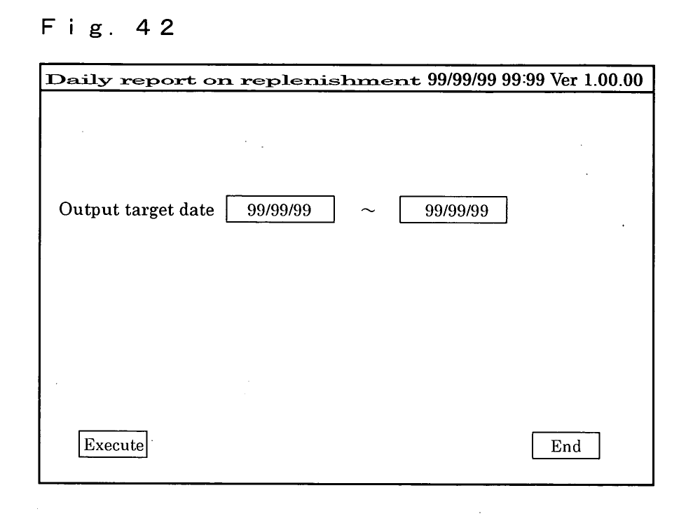

When the master maintenance button is operated, the display is switched to a master maintenance screen shown in FIG. 30, where a client master button, a medicine master button and the like are displayed. By operating the medicine master button, the display switched to a medicine master screen shown in FIG. 40, where a list of medicine information can be displayed. In the screen, a reference inventory quantity refers to a maximum inventory capacity of medicines, and an appropriate inventory quantity refers to a minimum inventory quantity which requires replenishment.

By operating the replenishing operation button, the display is switched to a replenishing operation screen shown in FIG. 35, where a list of a replenishment quantity, a medicine quantity before replenishment, and a medicine quantity after replenishment per cassette 2 can be displayed.

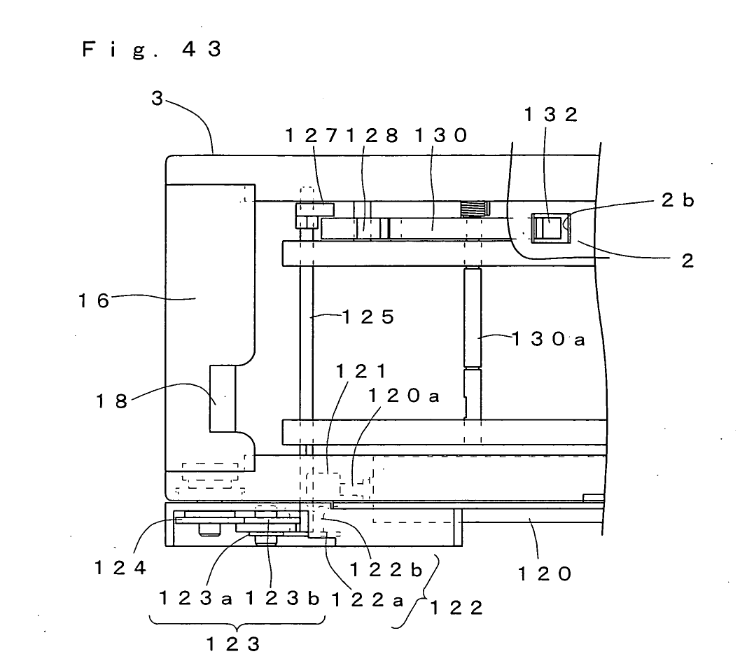

By operating the daily report button, the display is switched to a daily report menu screen shown in FIG. 41, where a discharge daily report button and a daily report on replenishment button are displayed. By operating the replenishment daily report button, the display is switched to a replenishment daily report screen shown in FIG. 42, where a list of replenishment status of medicines can be displayed by inputting a desired data for the status output. This makes it possible to check replenishment errors and the like.

1-6. (canceled)

7. A medicine feeder, comprising:
a cassette for housing medicines in array;
biasing member for biasing the medicines in the cassette toward one end side; and
a discharge member disposed on one end portion of the cassette so as to be rotatable between a reception position and an extraction position, wherein
the discharge member has: a holding recess portion for holding only one medicine biased by the biasing member upon rotation to the reception position and for maintaining a holding state of the held medicine so that the medicine can be extracted from outside upon rotation to the extraction position; and a support face formed on an opposite side of the holding recess portion so as to be able to support a next medicine when the discharge member rotates to the extraction position.

8. The medicine feeder as defined in claim 7, further comprising: medicine detection member for detecting whether or not a medicine is present in the holding recess portion when the discharge member is positioned at the extraction position; and control device for allowing driving of the discharge member based on prescription data and a detection signal in the medicine detection member.

9. The medicine feeder as defined in claim 8, further comprising lock member for disabling the discharge member from rotating, wherein the control device controls the lock member so as to lock the discharge member at the reception position when discharge of a prescribed quantity of medicines based on prescription data is completed.

10. The medicine feeder as defined in claim 7, wherein the discharge member has a notch to facilitate holding of the medicine on opposite walls constituting the holding recess portion.

11. A medicine feeder, comprising:
a cassette for housing medicines in array;
biasing member for biasing the medicines in the cassette toward one end side;
a discharge member disposed on one end portion of the cassette so as to be rotatable between a reception position and an extraction position; and
medicine quantity detection member for detecting a quantity of the medicines in the cassette; wherein
the medicine quantity detection member having: a sensor for detecting a biased position by the biasing member in an initial state where medicines are not housed in the cassette; and an encoder for detecting change in the biased position of medicines by the biasing member caused by housing the medicines in the cassettes from the initial state detected by the sensor.

12. A medicine feeder, comprising:
a cassette for housing medicines in array;
biasing member for biasing the medicines in the cassette toward one end side;
and a discharge member disposed on one end portion of the cassette for holding a medicine in a holding recess portion and discharging the medicine one by one through rotating movement, wherein
the discharge member comprises a rotor, and an outer circumferential face of the rotor for supporting a next medicine is formed so as not to change a position of the next medicine through rotating movement.

13. A medicine feeder, comprising:
a cassette for housing medicines in array;
biasing member for biasing the medicines in the cassette toward one end side;
and a discharge member disposed on one end portion of the cassette for holding a medicine in a holding recess portion and discharging the medicine one by one through rotating movement, wherein
the discharge member comprises a rotor, and
the control device automatically returns the rotor to a standby position if a specified time is passed while the rotor is positioned at a discharge position.

14. A medicine feeder, comprising:
a cassette for housing medicines in array;
biasing member for biasing the medicines in the cassette toward one end side;
and a discharge member disposed on one end portion of the cassette for holding a medicine in a holding recess portion and discharging the medicine one by one through rotating movement, wherein
the cassette is disposed so that housed medicines are arrayed in horizontal direction so as to be discharged one by one in sequence from one end side by the discharge member.

15. A medicine feeder, comprising:
a cassette for housing medicines in array;
biasing member for biasing the medicines in the cassette toward one end side;
and a discharge member disposed on one end portion of the cassette for holding a medicine in a holding recess portion and discharging the medicine one by one through rotating movement, wherein
the cassette is disposed so that housed medicines are arrayed in vertical direction so as to be discharged one by one in sequence from an upper end by the discharge member.

16. A medicine feeder, comprising:
a cassette for housing medicines in array;
biasing member for biasing the medicines in the cassette toward one end side;
and a discharge member disposed on one end portion of the cassette for holding a medicine in a holding recess portion and discharging the medicine one by one through rotating movement, wherein
the cassette is disposed so that vials containing medicines with an upper aperture closed by a lid are housed in a state of being arrayed in horizontal direction in a standing position.

17. A medicine feeder, comprising:
a cassette for housing medicines in array;
biasing member for biasing the medicines in the cassette toward one end side;
and a discharge member disposed on one end portion of the cassette for holding a medicine in a holding recess portion and discharging the medicine one by one through rotating movement, wherein
the discharge member comprises a rotor, and the cassette is structured to be mounted on and dismounted from each housing portion of a stock shelf and has a lock member for preventing the rotor from rotating when the cassette is dismounted from the housing portion.

18. The medicine feeder as defined in claim 8, wherein the discharge member has a notch to facilitate holding of the medicine on opposite walls constituting the holding recess portion.

19. The medicine feeder as defined in claim 9, wherein the discharge member has a notch to facilitate holding of the medicine on opposite walls constituting the holding recess portion.
